(19) United States
(12) Patent Application Publication
(10) Pub. No.: US 2022/0276043 A1
(43) Pub. Date: Sep. 1, 2022

(54) SHAPE MEASURING DEVICE, SYSTEM WITH FABRICATING UNIT AND SHAPE MEASURING DEVICE, AND METHOD

(71) Applicants: Yoichi KAKUTA, Tokyo (JP); Yasuaki YOROZU, Kanagawa (JP)

(72) Inventors: Yoichi KAKUTA, Tokyo (JP); Yasuaki YOROZU, Kanagawa (JP)

(73) Assignee: Ricoh Company, Ltd., Ohta-ku, Tokyo (JP)

(21) Appl. No.: 17/637,664

(22) PCT Filed: Nov. 10, 2020
(86) PCT No.: PCT/IB2020/060545

§ 371 Date: Feb. 23, 2022

(30) Foreign Application Priority Data
Nov. 20, 2019 (JP) 2019-209552

(51) Int. Cl. G01B 11/25; G06T 7/521; B33Y 50/00; B29C 64/386

(52) U.S. Cl. CPC G01B 11/2518; G06T 7/521; B33Y 50/00; B29C 64/386; G06T 2207/30108; H04N 5/2256

(57) ABSTRACT

A shape measuring device includes an irradiation unit, an imaging unit, and a calculation unit. The irradiation unit irradiates a measured object with light. The imaging unit captures an image of a bright line formed on a surface of the measured object by the light. The calculation unit weights each bright line by an imaging accuracy of each bright line and calculates a shape of the measured object based on data of each weighted bright line.

### TECHNICAL FIELD

Embodiments of the present disclosure relate to a shape measuring device, a system, and a method of measuring the shape of a fabrication object.

### BACKGROUND ART

There have been developed fabricating apparatuses (so-called “3D printers”) that fabricate a three-dimensional fabrication object based on input data. As the method of performing three-dimensional fabrication, there have been proposed, for example, fused filament fabrication (FFF), selective laser sintering (SLS), material jetting (MJ), electron beam melting (EBM), and stereolithography employing stereolithography apparatus (SLA).

In addition, with the development of three-dimensional fabrication technology, there has been an increasing need to measure the shape of a three-dimensional fabrication object.

For example, PTL 1 (JP-2017-032340-A) discloses a shape measuring device that measures the shape of a test object.

However, in the related art such as PTL 1, since the detection accuracy in the vicinity of the contour of a test object is low, the measurement accuracy of the shape is reduced.

### CITATION LIST

### Patent Literature

[PTL 1]

JP-2017-032340-A

### SUMMARY OF INVENTION

### Problems to be Solved

In view of the above-described situation, an object of the present disclosure is to provide a shape measuring device, a shape measuring system, and a shape measuring method with enhanced measurement accuracy.

### Solution to Problem

According to an aspect of the present disclosure, a shape measuring device includes an irradiation unit, an imaging unit, and a calculation unit. The irradiation unit irradiates a measured object with light. The imaging unit captures an image of a bright line formed on a surface of the measured object by the light. The calculation unit weights each bright line by an imaging accuracy of each bright line and calculates a shape of the measured object based on data of each weighted bright line.

### Advantageous Effects of Invention

According to the present disclosure, there can be provided a shape measuring device, a shape measuring system, and a shape measuring method with improved measurement accuracy.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIGS. 1A, 1B, and 1C are diagrams illustrating a schematic configuration of hardware of an entire system in an embodiment of the present disclosure.

FIGS. 2A and 2B are diagrams illustrating measurement of shape by a light section method.

FIGS. 3A, 3B, and 3C are diagrams illustrating comparative examples of test objects having shapes causing low detection accuracy.

FIG. 4 is a diagram illustrating a hardware configuration included in a three-dimensional fabricating apparatus with a shape sensor according to an embodiment of the present disclosure.

FIG. 5 is a block diagram of software included in the three-dimensional fabricating apparatus with the shape sensor according to the embodiment.

FIG. 6 is a flowchart illustrating a process in which the shape sensor according to the embodiment measures a shape.

FIGS. 7A to 7C are diagrams illustrating a first example in which break of a bright line is reduced in the embodiment.

FIGS. 8A and 8B are diagrams illustrating a second example in which break of a bright line is reduced in the embodiment.

FIGS. 9A and 9B are diagrams illustrating a third example in which break of a bright line is reduced in the embodiment.

FIGS. 10A and 10B are diagrams illustrating a fourth example in which break of a bright line is reduced in the embodiment.

FIG. 11 is a flowchart illustrating a process in which the shape sensor according to the embodiment measures a shape.

### DESCRIPTION OF EMBODIMENTS

Although the present disclosure is hereinafter described with reference to some embodiments, embodiments of the disclosure are not limited to the embodiments described below. In the drawings referred below, the same reference codes are used for the common elements, and the descriptions thereof are omitted as appropriate. In the embodiment described below, a three-dimensional fabricating apparatus including a shape measuring device, which is referred to as a shape sensor, is described as an example. However, for example, a system including a shape measuring device and a fabricating device may be used.

In the following description, a three-dimensional fabricating apparatus that fabricates a three-dimensional fabrication object by a fused filament fabrication (FFF) method is described as an example. However, embodiments of the present disclosure are not limited to the three-dimensional fabricating apparatus employing the FFF method but may be a three-dimensional fabricating apparatus employing any other fabrication method.

In the following description, the height direction of a fabrication object is referred to as z-axis direction, and a plane orthogonal to the z-axis direction is referred to as xy plane for convenience of explanation.

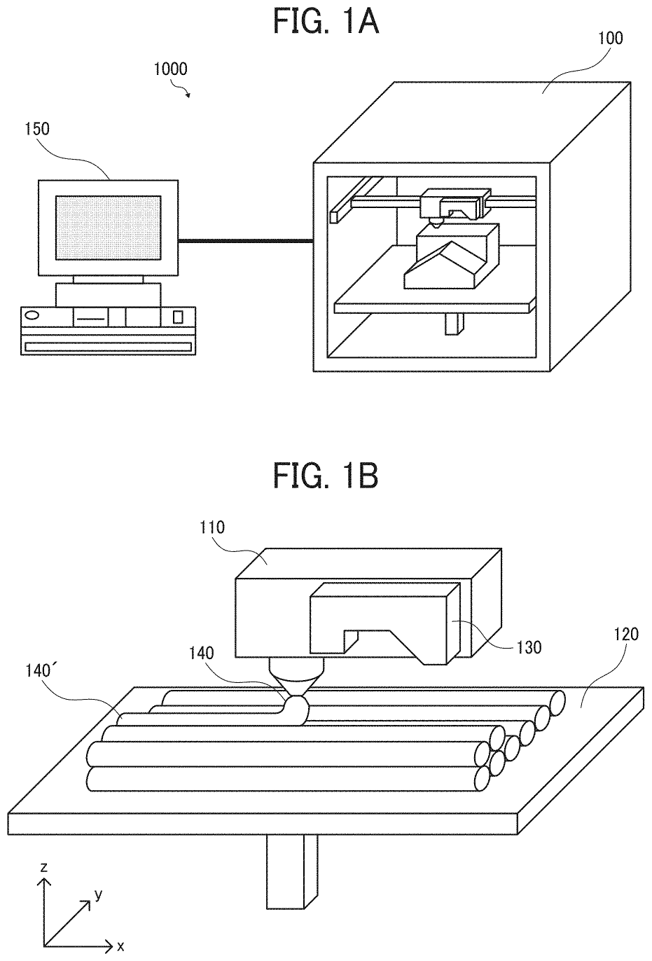

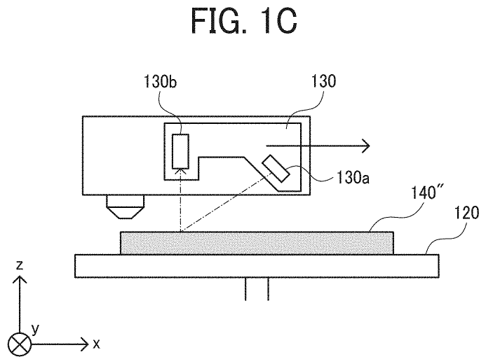

FIGS. lA to 1C are illustrations of a schematic configuration of an entire three-dimensional fabricating system according to an embodiment of the present disclosure. As illustrated in FIG. 1A, a three-dimensional fabricating system 1000 according to the present embodiment includes a three-dimensional fabricating apparatus 100 that fabricates a three-dimensional fabrication object. The three-dimensional fabricating apparatus 100 receives input of data (model data) indicating a three-dimensional shape of a fabrication object, for example, based on a fabrication request from an information processing terminal 150. The three-dimensional fabricating apparatus 100 fabricates a three-dimensional fabrication object based on the model data. The information processing terminal 150 may operate as a control device that controls a fabrication process executed by the three-dimensional fabricating apparatus 100.

Fabrication of the three-dimensional fabrication object by the FFF method is performed as illustrated in FIG. 1B. The three-dimensional fabricating apparatus 100 of the FFF method includes a fabricating device 110 including a head that discharges a molten fabrication material 140, and a stage 120 on which a fabrication object is fabricated. For example, a filament may be used as the fabrication material 140. In the case of a three-dimensional fabrication object having a shape that requires a support material in a fabrication process, the fabrication material and the support material may be the same material or different materials.

The fabricating device 110 is connected to a main body of the three-dimensional fabricating apparatus 100 with a rail along the x-axis and a rail along the y-axis and is movable in parallel to the xy plane with the respective rails. The stage 120 is movable in the z-axis direction and the distance between the fabricating device 110 and a three-dimensional fabrication object to be fabricated is adjustable. Note that the fabricating device 110 does not necessarily have to be movable in the direction along the x-axis or the y-axis, and may be movable in any direction in the xy plane through combination of movements on the respective rails.

The fabricating device 110 moves while discharging the melted fabrication material 140 onto the stage 120, to fabricate a linearly-formed fabrication object 140′ (hereinafter, referred to as linear-shaped fabrication object 140′). The fabricating device 110 moves parallel to the xy plane while discharging the fabrication material 140, and thus the linear-shaped fabrication object 140′ is fabricated on the stage 120. The fabricating device 110 can continuously fabricate a plurality of linear-shaped fabrication objects having different angles in the same plane. Therefore, the linear-shaped fabrication object 140′ is not necessarily a line and can be fabricated in any shape.

Thus, a layered fabrication object 140″ (hereinafter referred to as fabrication layer) in which a plurality of linear-shaped fabrication objects 140′ are arranged in a single plane is fabricated. FIG. 1B illustrates, as an example, a state in which a second fabrication layer is fabricated after the first fabrication layer is fabricated.

After the first fabrication layer is fabricated, the stage 120 in FIG. 1B is lowered by the height (stacking pitch) of one layer in the direction along the z-axis. Then, the fabricating device 110 is driven in the same manner as the first fabrication layer to fabricate the second fabrication layer. The three-dimensional fabricating apparatus 100 repeats such operations to stack fabrication layers and fabricate a three-dimensional fabrication object. Then, the melted fabrication material 140 is cured, so that a three-dimensional fabrication object having a stable shape can be obtained.

In the description of the present disclosure, an assembly in which a plurality of fabrication layers are stacked is referred to as a “fabrication object”, and a finished product in which the fabrication process is completed is referred to as a “three-dimensional fabrication object” to distinguish the two.

The three-dimensional fabricating apparatus 100 according to the present embodiment includes a shape sensor 130 that measures the shape (measured object) of a fabrication object in the middle of fabrication or a three-dimensional fabrication object after fabrication by a so-called light section method. The light section method is a method in which a measured object is irradiated with linear light (hereinafter referred to as “slit light”) and the light reflected by the slit light is imaged. Thus, the shape of the measured object can be measured. The shape of the slit light is not necessarily a straight line and may be any shape.

For example, as illustrated in FIG. 1C, the shape sensor 130 includes a light source 130a and a camera 130b. The light source 130a irradiates a measured object with slit light. The camera 130b images a bright line formed on the measured object by irradiation with the slit light. The shape sensor 130 scans the measured object while irradiating the measured object with the slit light, thus allowing the shape of the measured object based on a change in the shape of a bright line. In a preferred embodiment, as illustrated in FIGS. 1B and 1C, the shape sensor 130 may have a configuration of cooperating with the fabricating device 110.

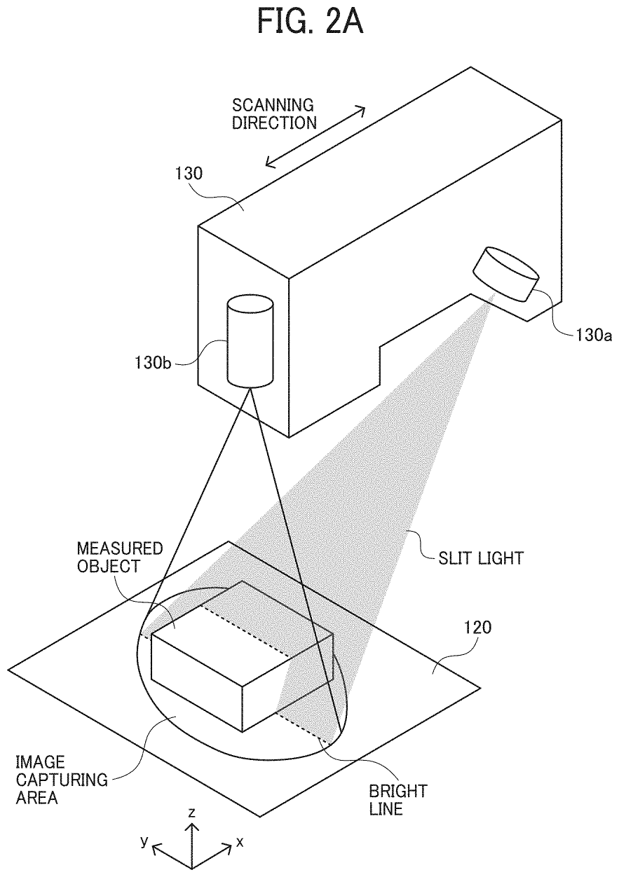

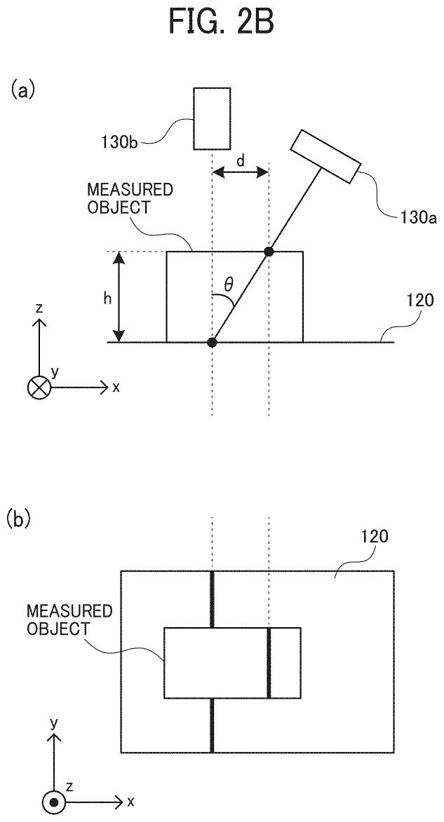

Here, the measurement of the shape of a three-dimensional fabrication object by the light section method is described with reference to FIGS. 2A and 2B. FIGS. 2A and 2B are diagrams illustrating the measurement of the shape by the light section method. FIG. 2A is a perspective view of FIG. 1C seen from a different angle and depicts a state in which the shape sensor 130 includes the light source 130a and the camera 130b as in FIG. 1C. The light source 130a irradiates a measured object with linear slit light having a fixed length. In FIG. 2A, as an example, the slit light has a length in a direction parallel to the y-axis. When the shape sensor 130 moves in the direction along the x-axis, the relative positions between the irradiation position of the slit light and the measured object change. Thus, the measured object can be scanned with the slit light.

Further, as illustrated in FIG. 2A, the camera 130b is disposed at a position having an optical axis inclined with respect to the optical axis of the slit light and images a bright line (indicated by a broken line in FIG. 2A) on the surface of the measured object. Here, the bright line formed on the surface of the measured object is described.

Part (a) of FIG. 2B is a side view of a measured object viewed from the zx-plane side. Part (b) of FIG. 2B is a top view of the measured object viewed from the xy-plane side. Black circles in part (a) of FIG. 2B and bold lines in part (b) of FIG. 2B indicate positions at which bright lines are formed.

As illustrated in parts (a) and (b) of FIG. 2B, the bright line formed on the surface of the measured object and the bright line formed on the stage 120 have different coordinates in the x-axis direction. This is because the slit light is irradiated from an oblique direction to the measured object having a certain height. The angle 0 formed by the optical axis of the slit light and the optical axis of the camera 130b is determined by the design of the shape sensor 130 and is known in advance. The distance d between the bright line formed on the measured object and the bright line formed on the stage 120 can be calculated from an image captured by the camera 130b. Therefore, the height h of the measured object can be calculated by the following Equation 1 according to the principle of trigonometry.

h=d/tan θ Equation 1

Note that the height h of the measured object depends on the detection accuracy of the distance d between bright lines.

The shape of the bright line imaged by the camera 130b changes in accordance with the shape of a portion irradiated with the slit light. Therefore, the shape of the measured object can be specified based on the height calculated by Equation 1 and the shape change of the bright line imaged by scanning the measured object with the slit light.

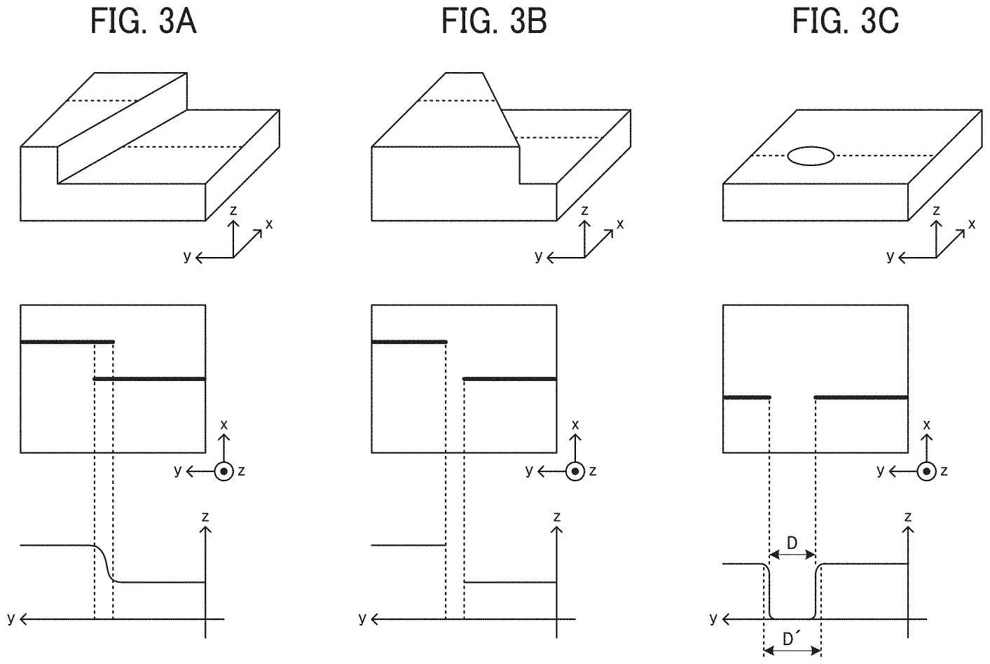

Next, a case in which a bright line formed on the surface of a measured object is not appropriately detected is described. FIGS. 3A, 3B, and 3C are diagrams illustrating comparative examples of test objects having shapes causing low detection accuracy. The upper parts of FIGS. 3A, 3B, and 3C are perspective views of measured objects. The middle parts of FIGS. 3A, 3B, and 3C are top views of images of bright lines captured by the camera 130b. The lower parts of FIGS. 3A, 3B, and 3C illustrate the height distributions of detected measured objects, that is, the cross-sectional shapes of detected measured objects. The slit light emitted by the light source 130a is obliquely emitted from the back side toward the front side in the x-axis direction.

In the case of a measured object having the shape illustrated in the upper part of FIG. 3A, as illustrated in the middle part of FIG. 3A, a region in which bright lines overlap in the y-axis direction occurs. Accordingly, as illustrated in the lower part of FIG. 3A, the height of the overlapping region is not appropriately detected, and the detection accuracy in the vicinity of the contour decreases.

In the case of a measured object having the shape illustrated in the upper part of FIG. 3B, as illustrated in the middle part of FIG. 3B, a region in which the bright line is broken in the y-axis direction occurs. Accordingly, as illustrated in the lower part of FIG. 3B, since a region in which the height is indefinite occurs, the detection accuracy in the vicinity of the contour decreases.

Further, in the case of a measured object having a hole as illustrated in the upper part of FIG. 3C, the bright line enters a hole as illustrated in the middle part of FIG. 3C, so that a portion in which the position of the bright line is unclear occurs. In such a case, while the diameter of the hole of the measured object is D, the measured object is detected as a hole having a diameter of D′ as illustrated in the lower part of FIG. 3C, and thus the measurement accuracy of the measured object decreases.

Even in a shape other than the shapes illustrated in FIGS. 3A, 3B, and 3C, in a case in which the shape of the measured object is complicated, a plurality of steps are included in the measured object. Accordingly, a large number of overlaps, breaks, and the like of bright lines occur. In other words, since an image in which the imaging accuracy of the bright line is different for each portion is captured, the detection accuracy in the vicinity of the contour of the measured object decreases. In order to avoid such a decrease in detection accuracy, in the present embodiment, weighting based on the evaluation result of the bright line is performed for each contour, and the shape of the measured object is calculated based on data of the weighted bright line.

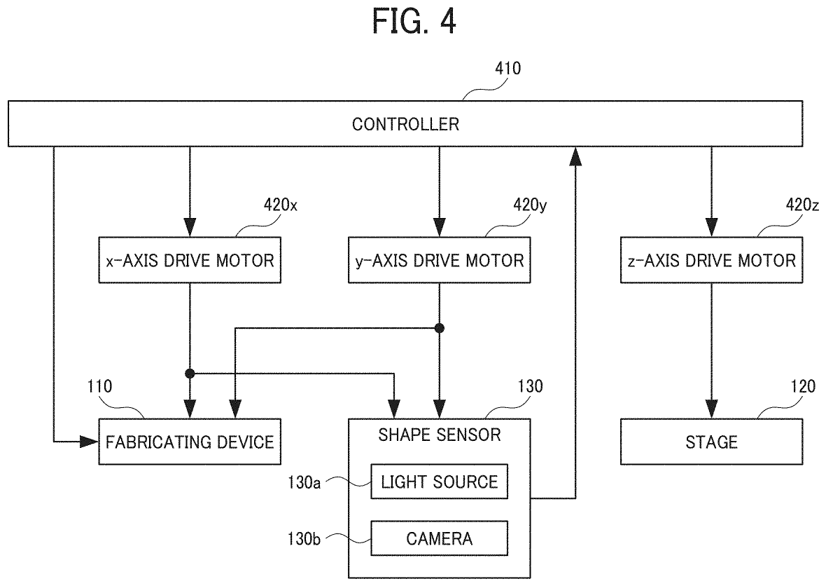

Next, a hardware configuration of the three-dimensional fabricating apparatus 100 is described. FIG. 4 is a diagram illustrating a hardware configuration included in the three-dimensional fabricating apparatus 100 including the shape sensor 130 according to the present embodiment. In addition to the fabricating device 110, the stage 120, and the shape sensor 130 illustrated in FIG. 1, the three-dimensional fabricating apparatus 100 includes a controller 410 and drive motors 420 (for example, an x-axis drive motor 420x, a y-axis drive motor 420y, and a z-axis drive motor 420z illustrated in FIG. 4) that control the positions of various types of hardware.

The controller 410 is, for example, a processing device such as a central processing unit (CPU) and executes a program for controlling the operation of the three-dimensional fabricating apparatus 100 to perform predetermined processing. For example, the controller 410 may control operations of the x-axis drive motor 420x, the y-axis drive motor 420y, and the z-axis drive motor 420z. The controller 410 can control the operation of the fabricating device 110 to control the discharge of the fabrication material 140. The controller 410 can acquire the shape data of a measured object obtained by the shape sensor 130 and can correct the shape of a fabrication object with the shape data in the fabrication process.

The x-axis drive motor 420x and the y-axis drive motor 420y can move the fabricating device 110 and the shape sensor 130 in the xy plane, and the z-axis drive motor 420z can control the height of the stage 120.

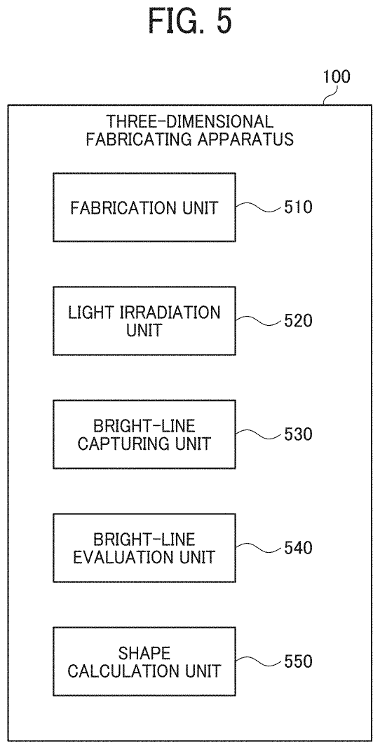

The hardware configuration included in the three-dimensional fabricating apparatus 100 including the shape sensor 130 according to the present embodiment has been described above. Next, functional units implemented with hardware of the present embodiment are described with reference to FIG. 5. FIG. 5 is a block diagram of software included in the three-dimensional fabricating apparatus 100 with the shape sensor 130 according to the present embodiment.

The three-dimensional fabricating apparatus 100 includes a fabrication unit 510, a light irradiation unit 520, a bright-line imaging unit 530, a bright-line evaluation unit 540, and a shape calculation unit 550. Each of the functional units are described in detail below.

The fabrication unit 510 controls the operation of the fabricating device 110 based on fabrication data to perform fabrication processing. For example, the fabrication unit 510 controls the operations of the fabricating device 110, the x-axis drive motor 420x, and the y-axis drive motor 420y based on a tool path included in the fabrication data. The fabrication unit 510 can control the z-axis drive motor 420z according to, e.g., the stacking pitch or the fabrication material 140 to adjust the position of the stage 120.

The light irradiation unit 520 controls the light source 130a to irradiate a measured object such as a fabrication object in the middle of fabrication or a completed three-dimensional fabrication object with slit light.

The bright-line imaging unit 530 controls the camera 130b to capture an image including a bright line formed on the surface of the measured object.

The bright-line evaluation unit 540 evaluates a bright line included in an image captured by the bright-line imaging unit 530. For example, the bright-line evaluation unit 540 can evaluate the measurement accuracy of each bright line based on whether a bright line included in the image is broken, the distance between bright lines in the case in which a bright line is broken, or the like. The result evaluated by the bright-line evaluation unit 540 is output to the shape calculation unit 550.

The shape calculation unit 550 calculates the shape of the measured object based on the bright line included in the image captured by the bright-line imaging unit 530. The shape calculation unit 550 can correct the data related to the bright line based on the evaluation result output by the bright-line evaluation unit 540 to calculate the shape. For example, the shape calculation unit 550 can weight each bright line for each contour of the measured object with the evaluation result of each bright line to correct each bright line, and calculate the shape based on data of the corrected bright line. Accordingly, since the shape can be calculated based on the bright line of the contour portion with high measurement accuracy, the accuracy of calculating the shape of the measured object can be enhanced.

The software blocks described above correspond to functional units implemented by a CPU executing a program according to the present embodiment to function each hardware. All the functional units illustrated in each embodiment may be implemented in software, or part or all of the functional units may be implemented as hardware that provides equivalent functions.

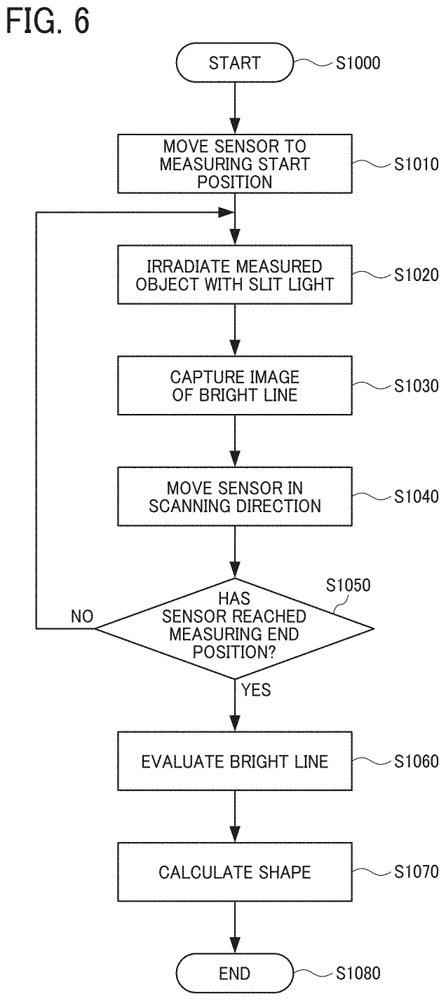

Next, a process of measuring the shape of a measured object, which is executed in the present embodiment, is described with reference to FIG. 6. FIG. 6 is a flowchart illustrating a process in which the shape sensor 130 according to the present embodiment measures a shape.

The shape sensor 130 starts the process from step S1000. In step S1010, the x-axis drive motor 420x and the y-axis drive motor 420y are operated to move the shape sensor 130 to a shape measuring start position.

Next, in step S1020, the light irradiation unit 520 controls the light source 130a to irradiate a measured object with slit light. Thereafter, in step S1030, the bright-line imaging unit 530 controls the camera 130b to capture an image of a bright line formed on the measured object and the stage 120.

After the image of the bright line is captured in step S1030, the shape sensor 130 moves in a scanning direction in step S1040. In other words, the irradiation position of a bright line and the capturing position of an image are moved by a unit distance in the scanning direction.

Then, in step S1050, the process branches depending on whether the shape sensor 130 has reached a shape measuring end position. When the shape sensor 130 has not reached a shape measuring end position (NO in step S1050), the process returns to step S1020, and the processing of steps S1020 to S1040 are repeated. Thus, the shape sensor 130 can scan the surface of the measured object with slit light and continuously acquire images of a plurality of bright lines.

On the other hand, when the shape sensor 130 has reached the shape measuring end position (YES in step S1050), the process proceeds to step S1060. In step S1060, the bright-line evaluation unit 540 evaluates a bright line included in the acquired image. Examples of the evaluation content include the continuity of bright lines, the distance between bright lines when the bright lines are broken, and the height dimension (dimension in the z-axis direction) of a measured object calculated based on the distance between bright lines. When there are a plurality of bright line images, the bright-line evaluation unit 540 can evaluate each bright line of each image.

After the bright lines are evaluated in step S1060, in step S1070, the shape calculation unit 550 calculates the shape of the measured object based on the bright lines and the evaluation results. In the calculation of the shape, for example, the shape can be calculated by weighting a bright line included in each captured image with the evaluation result for each contour of the measured object. More specifically, in a case where an image in which bright lines are broken is captured, the shape is calculated using a contour portion in which the distance between bright lines is smaller rather than a contour portion in which the distance between bright lines is larger. Thus, the shape can be calculated with enhanced accuracy of the contour. Weighting with the evaluation result may be performed in accordance with the use of the calculated shape. The calculated shape data of the measured object is output to, for example, the controller 410. Then, in step S1080, the shape sensor 130 ends the process of measuring the shape.

The process illustrated in FIG. 6 allows the shape sensor 130 to perform shape measurement with high accuracy. In the case of measuring the shape of one line of bright line, in other words, in the case of measuring the height of a portion irradiated with slit light, the processing of S1040 and S1050 may be skipped.

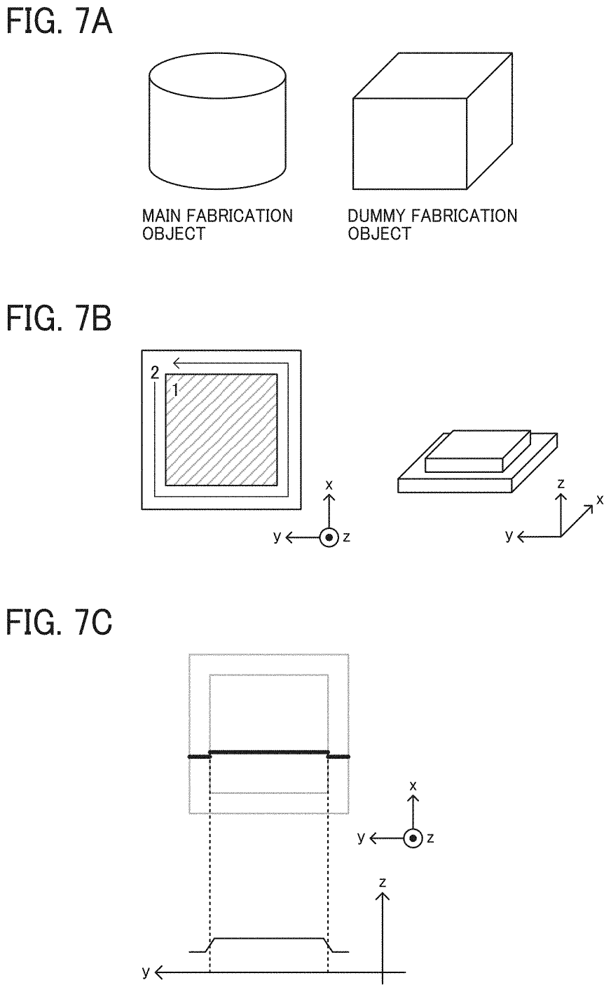

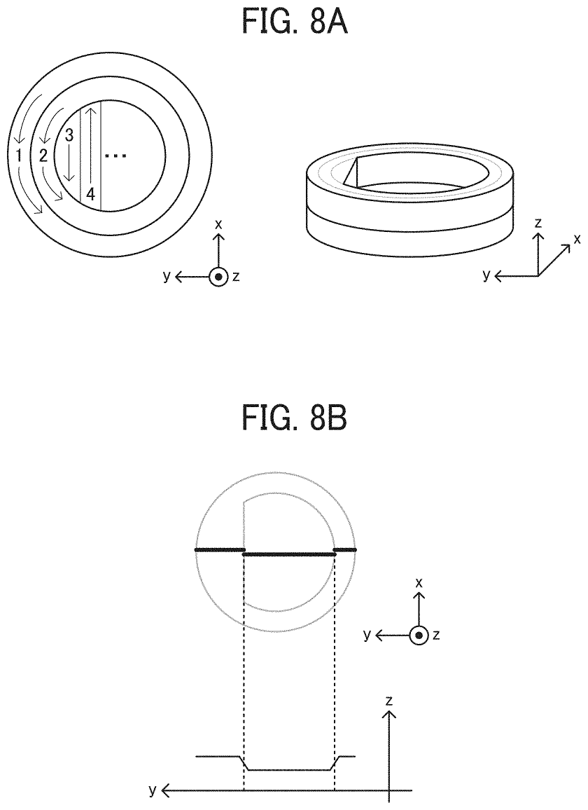

As described with reference to FIG. 2, in the measurement of the shape by the light section method, the accuracy of the shape in the vicinity of the contour may decrease due to the break of the bright line caused by the height of the measured object. Therefore, in the present embodiment, the accuracy of measuring the shape is enhanced by creating a state in which the break of the bright line is small. Hereinafter, four examples of the shape in which the break of the bright line is reduced are described with reference to FIGS. 7A to 10B. FIGS. 7A to 10B are diagrams illustrating examples in which the break of a bright line is reduced in the present embodiment. FIGS. 7A to 7C depict an example in which a dummy fabrication object is formed as a measured object. FIGS. 8A to 10B depict examples in which an internal structure in a process of fabricating a three-dimensional fabrication object having a shape desired by a user is a measured object.

In the first example, as illustrated in FIGS. 7A to 7C, a dummy fabrication object used for shape measurement is fabricated in addition to a main fabrication object that is a three-dimensional fabrication object having a shape desired by the user. Thus, a shape in which the break of the bright line is reduced is created. Here, as illustrated in FIG. 7A, an example in which the main fabrication object is a cylinder and the dummy fabrication object is a rectangular parallelepiped is described.

In order to reduce the distance at which a bright line is broken, a step corresponding to one fabrication layer is formed in the process of fabricating the rectangular-parallelepiped dummy fabrication object illustrated in FIG. 7A. The left drawing of FIG. 7B depicts a process of fabricating the dummy fabrication object, and the numbers in the left drawing indicate the order of fabrication. In other words, after a fabrication layer of a central portion of the dummy fabrication object is fabricated, a fabrication layer of a peripheral portion of the central portion is fabricated. The right drawing of FIG. 7B depicts the dummy fabrication object in the middle of fabrication, and depicts a state in which fabrication layers up to the fabrication layer in the central portion of the dummy fabrication object have been fabricated (a state in which the fabrication of the order 1 in the left drawing of FIG. 7B has been completed). When the shape is measured in such a state, an image of a bright line as illustrated in the upper diagram of FIG. 7C is captured.

The upper diagram of FIG. 7C is a top view of the measured object as viewed from the xy plane side and depicts the dummy fabrication object and the bright line formed on the dummy fabrication object. As illustrated in the upper diagram of FIG. 7C, a bright line is formed on a central portion of an upper layer and a peripheral portion of a lower layer of the dummy fabrication object. Here, since the step difference between the central portion of the upper layer and the peripheral portion of the lower layer corresponds to one fabrication layer, the break of the bright line is small, and the bright line is captured as a continuous bright line.

Accordingly, the cross-sectional shape of the dummy fabrication object is detected as a continuous shape as illustrated in the lower diagram of FIG. 7C, and the contour of the fabrication layer is also detected with high accuracy.

Next, a second example is described. In the second example, as illustrated in FIGS. 8A and 8B, in the process of fabricating a main fabrication object that is a three-dimensional fabrication object having a shape desired by the user, the order of tool passes is appropriately selected to create a shape in which the break of the bright line is small. In FIGS. 8A and 8B, similarly to FIG. 7A, an example in which the main fabrication object is a cylinder is described.

In order to reduce the distance at which the bright line is broken, the main fabrication object is fabricated in the order illustrated in the left drawing of FIG. 8A, and a step corresponding to one formation layer is formed. In other words, after two rounds of an outer peripheral portion of the cylinder are fabricated (order 1 and order 2), a central portion is fabricated (order 3, order 4, . . .). The right drawing of FIG. 8A depicts the main fabrication object in the middle of fabrication and depicts a state in which, among fabrication layers constituting the main fabrication object, the outer peripheral portion and a part of the central portion have been fabricated (a state in which fabrication of the order 3 in the left drawing of FIG. 8A has been completed). When the shape is measured in such a state, an image of a bright line as illustrated in the upper diagram of FIG. 8B is captured.

The upper diagram of FIG. 8B is a top view of the measured object as viewed from the xy plane side and depicts the main fabrication object and the bright line formed on the main fabrication object. As illustrated in the upper diagram of FIG. 8B, the bright line is formed on an outer peripheral portion of an upper layer, a part of a central portion of the upper layer, and a central portion of a lower layer in the main fabrication object. Here, since the step difference between the upper layer and the lower layer corresponds to one fabrication layer, the break of the bright line is small, and the bright line is captured as a continuous bright line. Accordingly, the cross-sectional shape of the main fabrication object is detected as a continuous shape as illustrated in the lower diagram of FIG. 8B, and the contour of the fabrication layer is also detected with high accuracy.

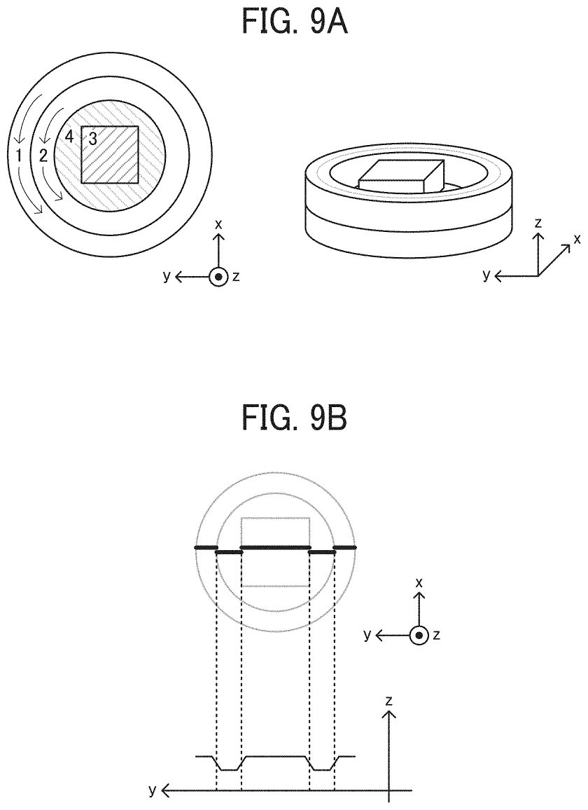

Next, a third example is described. In the third example, similarly to the second example, as illustrated in FIGS. 9A and 9B, in the process of fabricating a main fabrication object that is a three-dimensional fabrication object having a shape desired by the user, the order of tool passes is appropriately selected to create a shape in which the break of the bright line is small. In FIGS. 9A and 9B, similarly to FIG. 7A, an example in which the main fabrication object is a cylinder is described.

In order to reduce the distance at which the bright line is broken, the main fabrication object is fabricated in the order illustrated in the left drawing of FIG. 9A, and a step corresponding to one formation layer is formed. In other words, after two rounds of an outer peripheral portion of the cylinder are fabricated (order 1 and order 2), a central portion is fabricated (order 3, order 4, . . . ). Here, in the order 3, a rectangular part is formed in the central portion. Then, in the order 4, fabrication is performed to fill a space between the rectangular shape and the outer peripheral portion. The right drawing of FIG. 9A depicts the main fabrication object in the middle of fabrication and depicts a state in which, among fabrication layers constituting the main fabrication object, the outer peripheral portion and the rectangular part of the central portion have been fabricated (a state in which fabrication of the order 3 in the left drawing of

FIG. 9A has been completed). When the shape is measured in such a state, an image of a bright line as illustrated in the upper diagram of FIG. 9B is captured.

The upper diagram of FIG. 9B is a top view of the measured object as viewed from the xy plane side and depicts the main fabrication object and the bright line formed on the main fabrication object. As illustrated in the upper diagram of FIG. 9B, the bright line is formed on an outer peripheral portion of an upper layer, the rectangular part of a central portion of the upper layer, and a central portion of a lower layer in the main fabrication object. Here, since the step difference between the upper layer and the lower layer corresponds to one fabrication layer, the break of the bright line is small, and the bright line is captured as a continuous bright line. Accordingly, the cross-sectional shape of the main fabrication object in the height direction of the main fabrication object is detected as a continuous shape as illustrated in the lower diagram of FIG. 9B, and the contour of the fabrication layer is also detected with high accuracy.

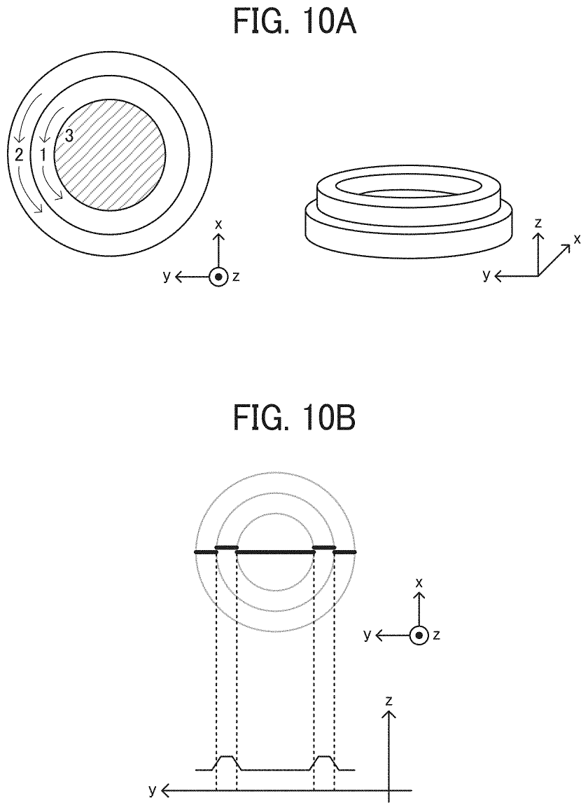

Next, a fourth example is described. In the fourth example, similarly to the second example and so on, as illustrated in FIGS. 10A and 10B, in the process of fabricating a main fabrication object that is a three-dimensional fabrication object having a shape desired by the user, the order of tool passes is appropriately selected to create a shape in which the break of the bright line is small. In FIGS. 10A and 10B, similarly to FIG. 7A, an example in which the main fabrication object is a cylinder is described.

In order to reduce the distance at which the bright line is broken, the main fabrication object is fabricated in the order illustrated in the left drawing of FIG. 10A, and a step corresponding to one formation layer is formed. In other words, after two rounds of an outer peripheral portion of the cylinder are fabricated (order 1 and order 2), a central portion is fabricated (order 3). The right drawing of FIG. 10A depicts the main fabrication object in the middle of fabrication and depicts a state in which, among fabrication layers constituting the main fabrication object, a first outer peripheral portion has been fabricated (a state in which fabrication of the order 1 in the left drawing of FIG. 10A has been completed). When the shape is measured in such a state, an image of a bright line as illustrated in the upper diagram of FIG. 10B is captured.

The upper diagram of FIG. 10B is a top view of the measured object as viewed from the xy plane side and depicts the main fabrication object and the bright line formed on the main fabrication object. As illustrated in the upper diagram of FIG. 10B, the bright line is formed on a first outer peripheral portion of an upper layer, a second outer peripheral portion of a lower layer, and a central portion of the lower layer in the main fabrication object. Here, since the step difference between the upper layer and the lower layer corresponds to one fabrication layer, the break of the bright line is small, and the bright line is captured as a continuous bright line. Accordingly, the cross-sectional shape of the main fabrication object in the height direction of the main fabrication object is detected as a continuous shape as illustrated in the lower diagram of FIG. 10B, and the contour of the fabrication layer is also detected with high accuracy.

As in the examples illustrated in FIGS. 7A to 10B, reducing the distance at which a bright line is broken allows capture of an image of a continuous bright line. Thus, the contour of the fabrication object can be detected with enhanced accuracy to measure the shape. Note that the shapes of the main fabrication object and the dummy fabrication object may be different from the shapes illustrated in FIGS. 7A to 10B. The orders of fabrication illustrated in FIGS. 7A to 10B are examples, and embodiments of the present disclosure are not particularly limited to the orders illustrated in FIGS. 7A to 10B. Further, in the examples of FIGS. 7A to 10B, the cases are illustrated in which the step difference between the upper layer and the lower layer corresponds to one fabrication layer. However, embodiments of the present disclosure are not particularly limited to the examples of FIGS. 7A to 10B. The step difference may correspond to two or more fabrication layers as long as the step difference can sufficiently reduce the distance at which the bright line is broken.

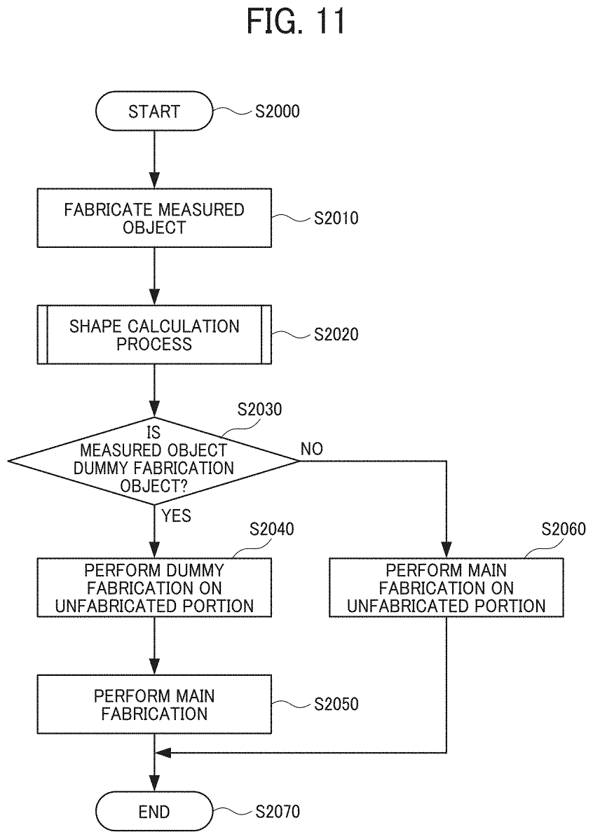

The measurement process illustrated in FIGS. 7A to 10B, which is performed by the three-dimensional fabricating apparatus 100, is described below. FIG. 11 is a flowchart of a process in which the shape sensor 130 according to the present embodiment measures the shape, and depicts a process of measuring the shape in a state in which the distance at which a bright line is broken is small.

The three-dimensional fabricating apparatus 100 starts the process from step S2000. In step S2010, the fabrication unit 510 fabricates a measured object. In the fabrication processing in step S2010, as illustrated in FIGS. 7A to 10B, it is preferable to fabricate a shape in which the distance at which a bright line is broken at the time of measurement is small. Therefore, examples of the shape fabricated in step S2010 include the shape illustrated in the right drawing of FIG. 7B, the shape illustrated in the right drawing of FIG. 8A, the shape illustrated in the right drawing of FIG. 9A, and the shape illustrated in the right drawing of FIG. 10A.

Then, in step S2020, the shape of the measured object is measured and calculated. Note that the process in step S2020 corresponds to the process in steps 51000 to 51080 in FIG. 6, and thus detailed descriptions thereof are omitted here. Since the shape measured in step S2020 is a shape in which the distance at which a bright line is broken is small, the contour of the measured object is also detected with high accuracy.

Then, in step S2030, the process is branched depending on whether the measured object, in other words, the fabrication object fabricated in step S2010 is a dummy fabrication object.

When the dummy fabrication object as illustrated in FIGS. 7A to 7C is fabricated and measured (YES in step S2030), the process proceeds to step S2040. In step S2040, the fabrication unit 510 fabricates an unfabricated portion of the dummy fabrication object. In order to enhance the accuracy of the main fabrication object, the shape may be measured again after the dummy fabrication object is completed. After step S2040, the process proceeds to step S2050, and the fabrication unit 510 fabricates the main fabrication object. Then, the process ends in step S2070.

On the other hand, when the measured object is fabricated and measured by selecting the order of the tool paths of the main fabrication object as illustrated in FIGS. 8A to 10B (NO in step S2030), the process proceeds to step S2060. In such a case, since the measurement is performed on the main fabrication object in the middle of fabrication, the fabrication unit 510 fabricates an unfabricated portion of the main fabrication object in step S2060. Then, the process ends in step S2070.

The process illustrated in FIG. 11 allows the shape to be measured in a state in which the distance at which a bright line is broken is small. Accordingly, the measurement accuracy of the measured object can be enhanced.

According to the above-described embodiments of the present disclosure, there can be provided a shape measuring device, a shape measuring system, and a shape measuring method with enhanced measurement accuracy.

Each of the functions of the above-described embodiments of the present disclosure can be implemented by a device-executable program written in, for example, C, C++, C#, and Java (registered trademark). The program according to an embodiment of the present disclosure can be stored in a device-readable recording medium to be distributed. Examples of the recording medium include a hard disk drive, a compact disk read only memory (CD-ROM), a magnetooptic disk (MO), a digital versatile disk (DVD), a flexible disk, an electrically erasable programmable read-only memory (EEPROM (registered trademark)), and an erasable programmable read-only memory (EPROM). The program can be transmitted over a network in a form with which another computer can execute the program.

Although the invention has been described above with reference to the embodiments, the invention is not limited to the above-described embodiments. Within the range of embodiments that can be estimated by skilled person, those exhibiting functions and effects of the invention are included in the scope of the invention. The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above. Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority to Japanese Patent Application No. 2019-209552, filed on Nov. 20, 2019, in the Japan Patent Office, the entire disclosure of which is hereby incorporated by reference herein.

### REFERENCE SIGNS LIST

100 Three-dimensional fabricating apparatus

110 Fabricating device

120 Stage

130 Shape sensor

130a Light source

130b Camera

140 Fabrication material

150 Information processing terminal

410 Controller

420 Drive motors

510 Fabrication unit

520 Light irradiation unit

530 Bright-line imaging unit

540 Bright-line evaluation unit

550 Shape calculation unit

1. A shape measuring device comprising:
light source configured to irradiate a measured object with light;
camera configured to capture an image of a bright line formed on a surface of the measured object by the light; and
a controller configured to weight each bright line by an imaging accuracy of each bright line and calculate a shape of the measured object based on data of each weighted bright line.

2. The shape measuring device according to claim 1,
wherein, when the image is captured as an image in which a bright line is broken into a plurality of bright lines, the controUer is configured to weight the bright line according to a distance between the plurality of bright lines.

3. A system comprising:
a fabricating devicc configured to fabricate a measured object;
light source eonfigured to irradiate the measured object with light;
camera configured to capture an image of a bright line formed on a surface of the measured object by the light; and
a controller configured to weight each bright line by an imaging accuracy of each bright line and calculate a shape of the measured object based on data of each weighted bright line.

4. The system according to claim 3,
wherein the fabrication device is configured to fabricate the measured object having a step of a predetermined height, and
the controller is configured to calculate the shape based on a bright line formed in the step.

5. The system according to claim 4, wherein the measured object having the step is a dummy fabrication object fabricated separately from a three-dimensional fabrication object fabricated based on a fabrication request.

6. The system according to claim 4, wherein the measured object having the step is an internal structure of a fabrication object in a process of fabricating the fabrication object.

7. A method comprising:
irradiating a measured object with light;
capturing an image of a bright line formed on a surface of the measured object by the light;
weighting each bright line by an imaging accuracy of each bright line; and
calculating a shape of the measured object based on data of each weighted bright line.
